(19) United States
(12) Patent Application Publication
(10) Pub. No.: US 2005/0258631 A1
(43) Pub. Date: Nov. 24, 2005

(54) Binding apparatus

(76) Inventor: James D. Funkhouser, Red Key, IN (US)

Correspondence Address: Kevin H. Vanderleeden, Esq.;McCormick, Paulding & Huber LLP, City Place II, 185 Asylum Street, Hartford, CT, 06103, US

(21) Appl. No.: 10/847,221

(22) Filed: May 18, 2004

(51) Int. Cl. B42D 1/00

(52) U.S. Cl. 281/21.1

(57) ABSTRACT

A binding of the present invention includes a spine having a score line that defines a first fold section and a second fold section. The second fold section includes a means for adhering the spine to the sheets. The first fold section is attached to the front surface of the sheets and the second fold section is then folded over the first fold section at the score line. The second fold section is then urged toward the rear surface of the sheets until the second fold section contacts and adheres to the rear surface of the sheets forming the binding

### FIELD OF THE INVENTION

The present invention relates generally to an apparatus for binding a plurality of sheets. More particularly, the present invention relates to a one-piece binding used to bind a plurality of stacked sheets into a booklet or brochure.

### BACKGROUND OF THE INVENTION

Booklet and brochure bindings are well known in the prior art. Prior art bindings, however, have limitations that are currently not addressed. In particular, prior art bindings typically include two-pieces, a rear cover portion with an attached spine and a front cover portion. Such bindings are large, roughly the size of the sheets that are to be bound, and include front and back covers. It is often desirable, however, to bind sheets without a cover. Moreover, two-piece bindings tend to be relatively complicated to assemble and expensive to manufacture.

With the foregoing problems and concerns in mind, it is the general object of the present invention to provide a compact one-piece binding that does not include cover portions, that may be easily and securely attached to a plurality of stacked sheets and that is inexpensive to manufacture.

### SUMMARY OF THE INVENTION

It is an object of the present invention to provide a binding that allows an individual to easily and securely bind together a plurality of stacked sheets.

It is a further object of the present invention to provide a compact one-piece binding that does not include cover portions.

It is an additional object of the present invention to provide a binding that is inexpensive to manufacture.

It is an additional object of the present invention to provide a method for utilizing present binding.

A preferred embodiment of the present invention is a binding for securing a plurality of stacked loose sheets having a front surface and a rear surface. The binding includes a spine having a score line that defines a first fold section and a second fold section. The second fold section includes a means for adhering the spine to the sheets. The first fold section is attached to the front surface of the sheets and the second fold section is then folded over the first fold section at the score line. The second fold section is then urged toward the rear surface of the sheets until the second fold section contacts and adheres to the rear surface of the sheets forming the binding.

This and other objects and advantages of this invention will be more readily appreciated from a reading of the specification in conjunction with the claims annexed hereto.

### BRIEF DESCRIPTION OF THE DRAWINGS

FIG. 1 is a perspective view of a two-piece prior art binding.

FIG. 2 is a perspective view of another two-piece prior art binding.

FIG. 3 is a top planar view of a binding in accordance with an embodiment of the present invention.

FIG. 4 is a perspective view of the binding of FIG. 3 illustrating the binding being attached to a plurality of stacked loose sheets.

FIG. 5 is an additional perspective view of the binding of FIG. 3 being attached to a plurality of stacked loose sheets.

FIG. 6 is an additional perspective view of the binding of FIG. 3 being attached to a plurality of stacked loose sheets.

FIG. 7 is an additional perspective view of the binding of FIG. 3 being attached to a plurality of stacked loose sheets.

FIG. 8 is a perspective view of the binding of FIG. 3 attached to a plurality of stacked loose sheets.

FIG. 9 is a top planar view of an alternative embodiment of a binding in accordance with the present invention.

### DETAILED DESCRIPTION OF THE PREFERRED EMBODIMENT

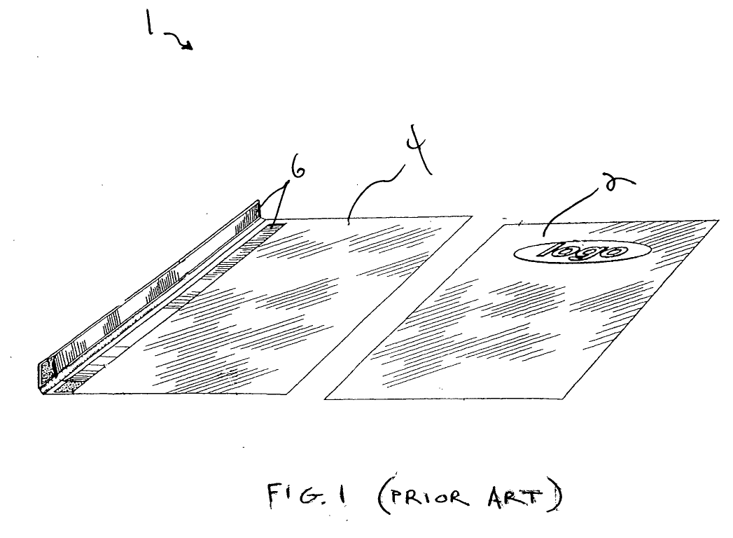

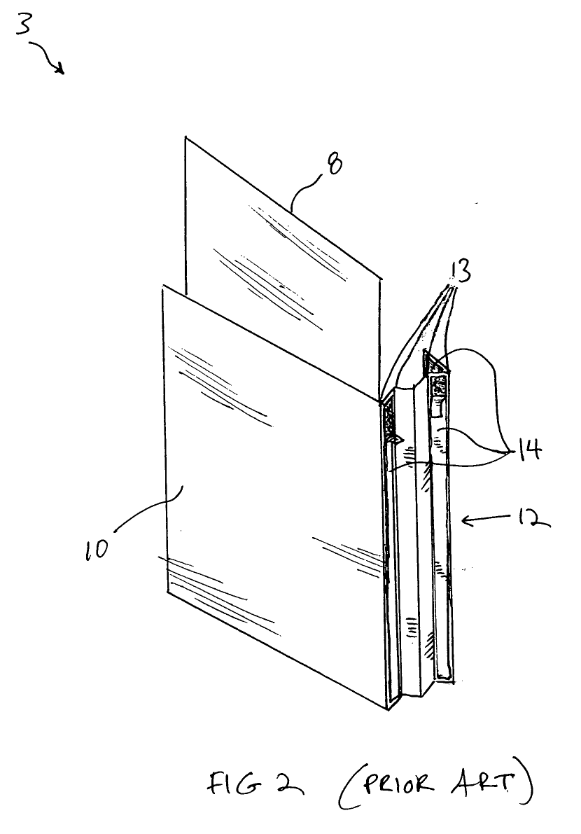

FIGS. 1 and 2 illustrate two examples of prior art bindings. FIG. 1 depicts a two-piece binding cover 1 that includes a front cover panel 2 and a rear cover panel 4. The rear cover panel 4 has two adhesive strips 6 affixed to it. FIG. 2 depicts another two-piece binding cover 3 that also includes a front cover panel 8 and a rear cover panel 10. The rear cover panel contains a spine 12, which is adapted to be folded to securely bind the stack of loose sheets. The spine 12 has multiple fold or score lines 13 and three adhesive strips 14.

As discussed in detail below, the present invention provides a one-piece binding that does not include cover panels as does the prior art bindings of FIGS. 1 and 2. Additionally, unlike the prior art binding 1 of FIG. 1, the inventive binding is securely attached to the front of the sheets through staples or like fasteners. The binding of FIG. 1 is adhered to the sheets and to the front cover 2 through the adhesive strips 6. Moreover, unlike the binding 3 of FIG. 2, the inventive binding has fewer score lines and has only one adhesive strip instead of three.

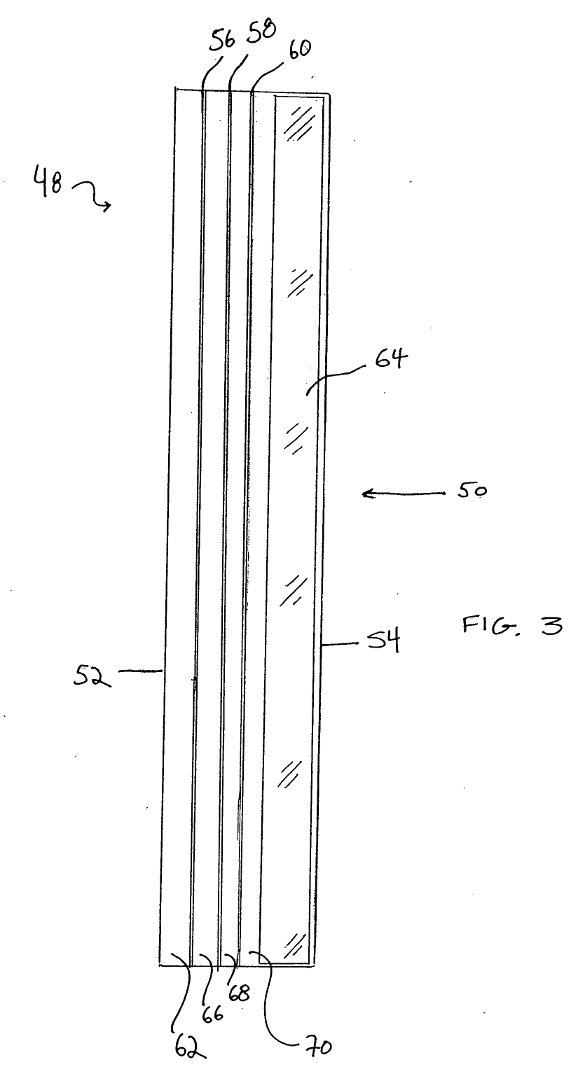

Referring now to FIG. 3, a preferred embodiment of the binding 48 of the present invention includes a spine 50 that is generally rectangular in shape. The spine 50 has a first peripheral edge portion 52 and a second peripheral edge portion 54. The spine 50 also contains a plurality of score lines that allow the spine to be folded and subsequently attached to a plurality of sheets. Specifically, the spine 50 contains a first score line 56 that is adjacent to the first edge of the spine 52. The spine also contains a second score line 58 that is adjacent to the first score line 56. The spine 50 also contains a third score line 60 that is adjacent to both the second edge 54 of the spine 50 and the second score line 58.

The unitary structure of the binding 48 is an important aspect of the present invention. As mentioned above, many prior art bindings include two pieces. The pieces generally include a spine with a front or back cover portion attached to the spine and a second cover portion.

The present invention, a one-piece binding 48, does not include cover portions. As such, the binding 48 is smaller and more convenient to use than prior art bindings. The binding 48 may also be used to bind a plurality of sheets without a front or back cover. Additionally, the present invention is less expensive to manufacture as it does not include cover portions and utilizes only a single adhesive strip 64 as opposed to the multiple strips employed by the prior art binding of FIG. 2.

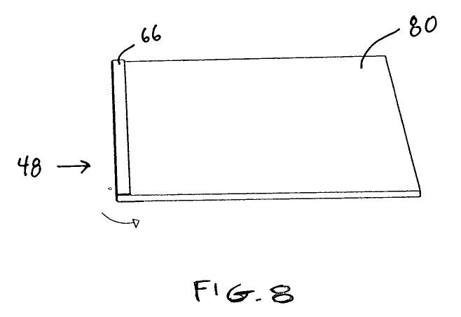

Returning again to FIG. 3, the score lines 56, 58, 60 define a plurality of fold sections. The spine 50 has a first fold section 62 that is between the first score line 56 and the first edge portion 52. The spine 50 also includes a second fold section 66, a third fold section 68 and a fourth fold section 70. The fourth fold section 70 supports thereon an adhesive strip 64 that extends substantially the length of the fourth fold section 70. A release strip 90 covers the adhesive strip 64 (FIG. 8).

The score lines 56, 58, 60 and the fold sections 62, 66, 68, 70 are additional important aspects of the present invention. As discussed in greater detail below, the configuration of the score lines 56, 58, 60 and the fold sections 62, 66, 68, 70 allows the binding to be fastened to the front surface of a plurality of sheets, folded over the sheets, and then fastened to the back or rear surface of the plurality of stacked sheets binding them together. Unlike prior art bindings, the above-described process is simplified and may be completed in essentially three steps. Prior art bindings, such as the binding shown in FIG. 2, require additional steps to bind a plurality of sheets. That is, the prior art binding of FIG. 2 has three adhesive strips that must be affixed to various fold sections and to the front cover of the binding. The present binding 48 has only a single adhesive strip 64 that is affixed directly to the rear surface of the sheets. Moreover, the binding 48 has fewer fold sections 62, 66, 68, 70 and requires fewer folds.

Returning again to FIG. 3, the fourth fold section 70 is sized to accommodate the adhesive strip 64 which, in turn, is sized to securely attach to and hold a plurality of sheets. The first and second fold sections 62, 66 are substantially the same width.

The widths of the various fold sections are yet another important aspect of the present invention. As mentioned above, the fourth fold section 70 has a width sufficient to accommodate an adhesive strip 64. The third fold section 68 forms the back of the spine 50 and has a width sufficient to accommodate a plurality of stacked sheets. The first fold section 62 is fastened to the front of the plurality of sheets and has a width sufficient to permit its fastening by mechanical means such as staples and like fasteners. Once the first fold section 62 is fastened to the sheets, the second fold section 66 is folded over the first fold section 62 to cover the fasteners. As such, the second fold section 66 has a width sufficient to fold over and cover the first fold section 62. Preferably, the second fold section 66 is substantially the same width as the first fold section 62.

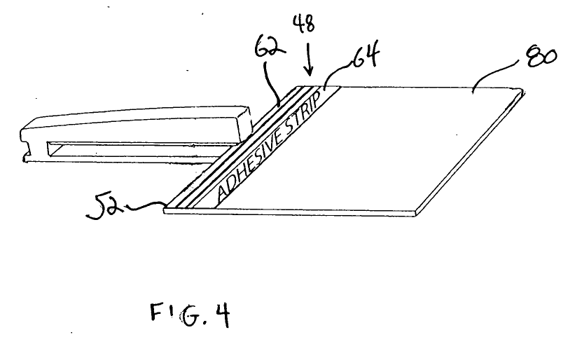

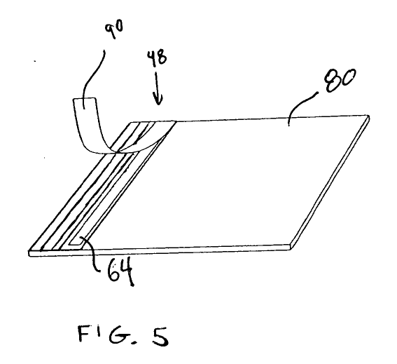

FIGS. 4-8 are all perspective views of a binding of the present invention being employed to bind a plurality of sheets. Referring to FIG. 4, the binding 48 is first placed on the front of a plurality of stacked loose sheets 80 with the adhesive strip 64 facing upward, and with the first edge portion 52 aligned with an edge of the sheets 80. The first fold section 62 is then fastened to the sheets by mechanical means such as staples or like fasteners. At this time, the release strip 90 may be removed from the adhesive strip 64 (FIG. 5).

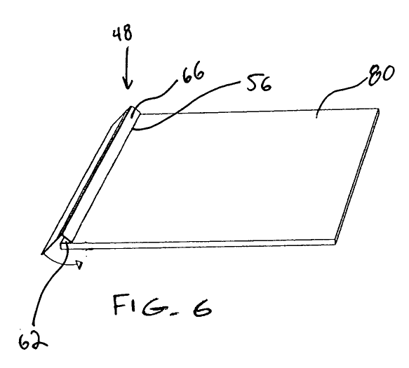

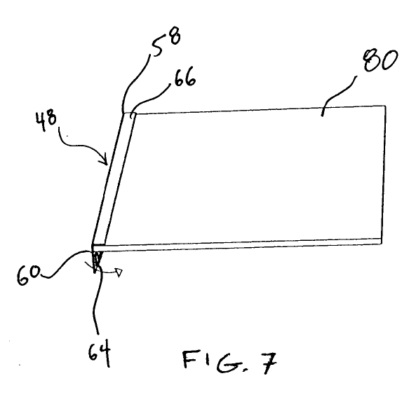

As shown in FIG. 6, the second fold section 66 is then folded over the first fold section 62 at the first score line 56 and the first fold section 62 containing the adhesive strip 64 is urged in a substantially arcuate path toward the rear of the plurality of sheets. The second score line 58 and third score line 56 are then folded to form the back of the spine (FIG. 7). Finally, the first fold section 62 is brought into engagement with and secured to the back or rear surface of the plurality of sheets with the adhesive strip 64 completing the binding (FIG. 8). In this way a simple, convenient, aesthetically pleasing binding is created.

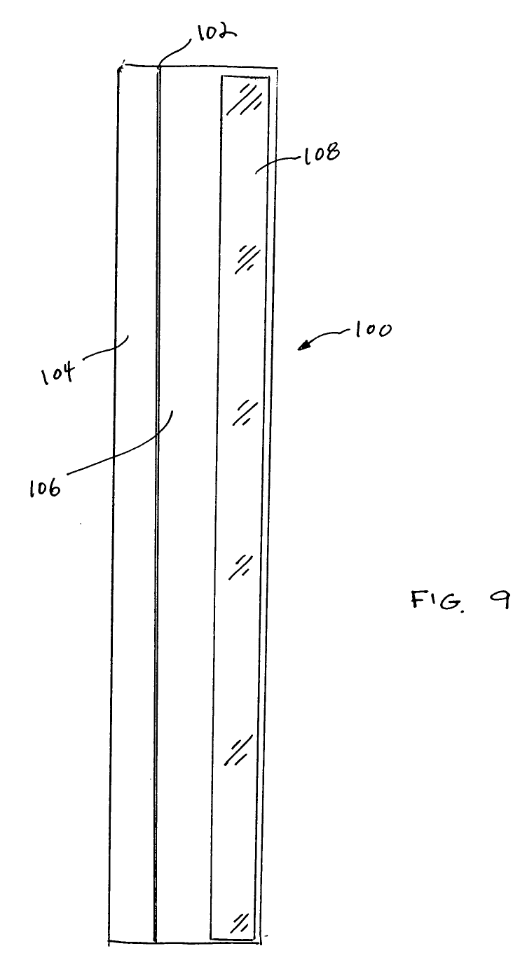

In an alternative embodiment shown in FIG. 9, the spine 100 includes a single score line 102 dividing the spine 100 into a first fold section or portion 104 and a second fold section or portion 106. The first fold section 104 is affixed to the plurality of sheets by mechanical means such as staples. The second fold section 106 contains an adhesion means such as an adhesive strip 108. In use, the first fold section 104 is attached to the front surface of a plurality of sheets with the adhesive strip 108 facing upward. The second fold section 106 is then folded over the first 104 at the score line 102 and then urged in a substantially arcuate path until the adhesive strip 108 is in contact with and is secured to the rear surface of the plurality of sheets forming the binding. This embodiment does not feature the squared or defined binding edge created by the second and third score lines 58, 60 (FIG. 3).

The foregoing description is intended to describe the preferred form of the invention and the best mode contemplated for carrying out this invention. To those skilled in the art, however, various modifications and variations to the specific embodiments described herein may be apparent without departing from the scope of the invention.

1. A binding for securing a plurality of stacked loose sheets having a front surface and a rear surface, said binding comprising:
a spine having a score line, said score line defining a first fold section and a second fold section;
a means for adhering the spine to the sheets, said means being affixed to the second fold section; and
wherein said first fold section is attached to the front surface of the sheets, the second fold section is then folded over the first fold section at the score line and urged toward the rear surface of the sheets until the second fold section contacts and adheres to the rear surface of the sheets forming the binding.

2. The binding of claim 1 wherein the means for adhering the spine includes adhesive strip covered by a release strip.

3. The binding of claim 1 wherein said spine is substantially rectangular in shape.

4. A one-piece binding for securing a plurality of stacked loose sheets, said binding comprising:
a spine having first, second and third score lines, said score lines defining first, second, third and fourth fold sections of the spine;
a means for adhering the spine to the sheets, said means being affixed to the fourth fold section; and
wherein said first fold section is attached to the front of the sheets, said second fold section is then folded over the first fold section at the third score line and the fourth fold section is urged toward the back of the sheets, said second score line and third score line are then folded and the fourth fold section is brought into engagement with and is adhered to the sheets forming the binding.

5. The binding of claim 4 wherein the means for adhering the spine includes adhesive strip covered by a release strip.

6. The binding of claim 4 wherein said spine is substantially rectangular in shape.

7. The binding of claim 4 wherein said first and second fold sections are substantially the same size.

8. The binding of claim 4 wherein said first and second fold sections are larger than said third fold section.

9. The binding of claim 4 wherein said fourth fold section is the largest of the fold sections.

10. A method for binding a plurality of stacked loose sheets, wherein the sheets are bound with a one-piece binding having a spine with first, second and third score lines, said score lines defining first, second, third and fourth fold sections, and a means for adhering the spine to the loose sheets, said means being affixed to the fourth fold section, the method comprising the following steps:
attaching the binding to the sheets by fastening the sheets to the first fold section of the binding;
folding the second fold section over the first fold section at the first score line;
urging the fourth fold section toward a back surface of the plurality of sheets;
folding the second score line and third score lines; and
securing the fourth fold section to the back surface of the sheets with the adhesion means.

11. The method of claim 10, wherein the step of attaching the binding to the sheets is accomplished by stapling the loose sheets to the first fold section.

12. The method of claim 10 wherein the adhesion means includes an adhesive strip covered by a release strip.

13. The method of claim 12 further including the step of removing the release strip from the adhesive strip before securing the fourth fold section to the back surface of the sheets.

14. The method of claim 10 further including the step of aligning the spine with an edge of the stacked sheets prior to attaching the binding to the sheets by fastening the sheets to the first fold section of the binding.

15. A method for binding a plurality of stacked loose sheets, wherein the sheets are bound with a one-piece binding having a spine with first, second and third score lines, said score lines defining first, second, third and fourth fold sections, and a means for adhering the spine to the loose sheets, said means being affixed to the fourth fold section, the method comprising the following steps:
aligning the spine with an edge of a front surface of the stacked loose sheets;
attaching the binding to the sheets by stapling the sheets to the first fold section of the binding;
folding the second fold section over the first fold section at the first score line;
urging the fourth fold section toward a back surface of the plurality of sheets;
folding the second score line and third score lines; and
securing the fourth fold section to the back surface of the sheets with the adhesion means.

16. The method of claim 15 wherein the adhesion means includes an adhesive strip covered by a release strip.

17. The method of claim 16 further including the step of removing the release strip from the adhesive strip before securing the fourth fold section to the back surface of the sheets.
